(19) United States
(12) Patent Application Publication
(10) Pub. No.: US 2010/0201522 A1
(43) Pub. Date: Aug. 12, 2010

(54) PRODUCT FIXTURE MONITORING SYSTEM AND METHOD OF MONITORING PRODUCT FIXTURES

(75) Inventor: Steven D. White, Austin, TX (US)

Correspondence Address: CAESAR, RIVISE, BERNSTEIN,;COHEN & POKOTILOW, LTD., 11TH FLOOR, SEVEN PENN CENTER, 1635 MARKET STREET, PHILADELPHIA, PA, 19103-2212, US

(73) Assignee: CHECKPOINT SYSTEMS, INC., Thorofare, NJ (US)

(21) Appl. No.: 12/767,469

(22) Filed: Apr. 26, 2010

Related U.S. Application Data
(62) Division of application No. 11/680,980, filed on Mar. 1, 2007.
(60) Provisional application No. 60/803,084, filed on May 24, 2006.

(51) Int. Cl. G08B 13/14; G06F 7/00

(52) U.S. Cl. 340/572.1; 700/213

(57) ABSTRACT

A system and method for monitoring the status of various types of fixtures and products sold in commercial, e.g., retail environments. The system is arranged to automatically detect and notify store personnel of undesirable conditions, specifically: out of stock, low-stock, and rapid product dispensing or removal. The system consists of an FMS Intelligent Controller (FMS-IC) which is a microprocessor based input/output device mounted on the monitored display device or fixture, and sensors that are connected to inputs used to trigger the FMS-IC when a sensor senses the presence of an item of merchandise to be monitored. The FMS is battery powered and is used with various embodiments of fixtures that may be mounted to shelves within the retail environment.

### CROSS-REFERENCE TO RELATED APPLICATIONS

This utility application claims the benefit under 35 U.S.C. §119(e) of Provisional Application Ser. No. 60/803,084 filed on May 24, 2006 entitled PRODUCT FIXTURE MONITORING SYSTEM AND METHOD OF MONITORING PRODUCT FIXTURES and whose entire disclosure is incorporated by reference herein.

### BACKGROUND OF THE INVENTION

1. Field of Invention

This invention relates generally to systems for displaying products or other items of merchandise in retail environments so that patrons can remove the items from the display for purchase, and more particularly to systems providing automatic detection and notification of undesirable item display conditions, e.g., out-of-stock or low-stock conditions, and rapid product dispensing or removal.

Organized Retail Theft (ORT), also known as Organized Retail Crime (ORC), is rapidly becoming the most significant area of loss for retailers. The cost for losses in retail are estimated to be up to thirty billion dollars annually, and traditional theft deterrents and countermeasures such as CCTV (Closed-Circuit Television) and EAS (Electronic Article Surveillance) are proving mostly ineffective. ORT often involves large theft rings with sophisticated distribution networks and repackaging operations. The thefts may be perpetrated by individuals or teams, who are instructed to steal large quantities of specific products. These teams are made up of low level members of the ORT ring, with all of their actions being directed from the upper tiers of the organization. The groups will usually target multiple stores in a single day, and annual incomes for thieves can exceed $100,000—making ORT highly lucrative.

Losses from the theft of merchandise alone are significant, but losses from the sales that are missed due to the lack of stock on the shelves are harder to measure. ORT thieves “sweep” the shelves of their target products—leaving none available for purchase.

Out-of-stock situations, whether caused by theft or regular sales, are harmful to retailers. They result in missed sales opportunities, threaten customer loyalty, and in some cases may even violate a retailer's legal obligations (such as WIC program requirements to maintain specific infant formula products on the shelves).

It has been reported that most ORT rings do not use force when stealing. Rather, they prefer to flee if detected. Moreover, the earlier during the theft that detection of it occurs, the lower the exposure of loss (since fewer products may be accumulated). Also, detecting shelf sweeping while the perpetrators are deep inside the store is a key benefit, since the closer they move toward the door, the more likely they are to flee with the product, versus dropping the items.

In summary, retailers would benefit from real-time information about the unusual movement of key products within their stores. Providing increased visibility to low and out-of-stock situations adds even more value to a product monitoring solution. The subject invention is designed to address those needs.

2. Description of Related Art

An automated drug dispensing system receiving a request signal and in response generates a dispense signal is shown by way of example in U.S. Pat. No. 6,814,255 (Liff, et al.) and an automated Self-Service Cafeteria System used to detect and identify when food is taken from a cabinet by a patron is shown within U.S. Pat. No. 6,102,162 (Teicher). Other inventory security systems are shown by U.S. Pat. Nos. 6,693,539 (Johnson), 5,151,684 (Bowers et al.), 6,600,418 (Francis et al.); a wireless directed inventory system in U.S. Pat. No. 6,650,225 (Bastian, II et al.); and, a personal inventory management system shown by example of U.S. Pat. No. 6,851,611 (Shaw-Sinclair).

All references cited herein are incorporated herein by reference in their entireties.

### BRIEF SUMMARY OF THE INVENTION

In accordance with one aspect of this invention there is provided a monitoring system for use with a product display device or fixture. The product display device or fixture is arranged to enable items of merchandise to be removed from it by patrons of a commercial environment. The product display device or fixture comprises at least one storage area for storing the plural items of merchandise and at least one outlet coupled to the storage area from which individual items of merchandise can be removed by the patrons or dispensed to the patrons.

The monitoring system comprises at least one sensor and at least one electronic device coupled to the at least one sensor. The at least one sensor is arranged to be located adjacent the at least one storage area or the at least one outlet to provide a first electrical signal to the electronic device whenever an item of merchandise has been removed or dispensed from the product display device or fixture. The electronic device is arranged to process the first electrical signals to enable the rate that the items of items merchandise are removed or dispensed from the product display device or fixture to be determined, thereby providing an indication of possible theft, e.g., large scale item theft.

In accordance with one preferred, but not mandatory, aspect of the invention the electronic device is microprocessor-based and the at least one sensor is arranged to provide a trigger signal to the microprocessor-based device upon the detection of an item of merchandise thereat, whereupon the microprocessor-based device initiates a timing window or period, e.g., an adjustable timing window or period, during which the microprocessor-based device counts the number of the first electrical signals (which number of first electrical signals to be counted is itself adjustable) and determines if the total number of first electrical signals received during the timing window or period reaches a preset threshold, and if so provides a “dispense rate alert signal” output.

In accordance with another aspect of this invention the invention is made up of the product display device or fixture and the monitoring system.

### BRIEF DESCRIPTION OF SEVERAL VIEWS OF THE DRAWINGS

The invention will be described in conjunction with the following drawings in which like reference numerals designate like elements and wherein:

FIG. 1 is a schematic diagram of one exemplary system constructed in accordance with the subject invention, the particular system being a system for monitoring dispensing/removal of cans of infant formula from plural, gravity-fed storage racks or fixtures;

FIG. 2 is a prospective view of the top of one exemplary monitoring controller, referred to hereinafter as the FMS-IC unit, forming a portion of the system shown in FIG. 1;

FIG. 3 is a bottom view showing the bottom of the monitoring controller shown in FIG. 2;

FIG. 4 is a side view of the monitoring controller of FIG. 2, showing its plural input connectors for receiving plural respective sensors (e.g., switch) inputs;

FIG. 5 is a prospective view of one exemplary storage/dispensing rack or fixture forming a portion of the system shown in FIG. 1;

FIG. 6 is a prospective view of an exemplary sensor, e.g., a microswitch, forming a portion of the system of FIG. 1;

FIG. 7 is a prospective view of an alternative product display device or fixture making use of the subject invention, e.g., a typical pusher fixture for dispensing items by pushing them out of the fixture (as opposed to making use of gravity to dispense the items from the fixture) and which is outfitted with one or multiple sensors to trigger the FMS-IC unit;

FIG. 8 is a prospective view showing two typical pusher devices that can be used in systems of the subject invention, the device shown below being an example of a single-switch pusher and the device shown above being an example of a multi-switch pusher;

FIG. 9A is a prospective view illustrating the operating mechanism of a pusher that can be used in the subject invention;

FIG. 9B is a close-up side view of a portion of the pusher mechanism shown in FIG. 9A;

FIG. 10 is prospective view of a pusher, like that of FIG. 7, but making use of a guard to prevent multiple products from being removed at one time;

FIG. 11 is a prospective view of still another exemplary pusher, but making use of guards; and

FIG. 12 is a prospective view of a simple peg hook incorporating a sensor to detect item removal therefrom.

### DETAILED DESCRIPTION OF THE INVENTION

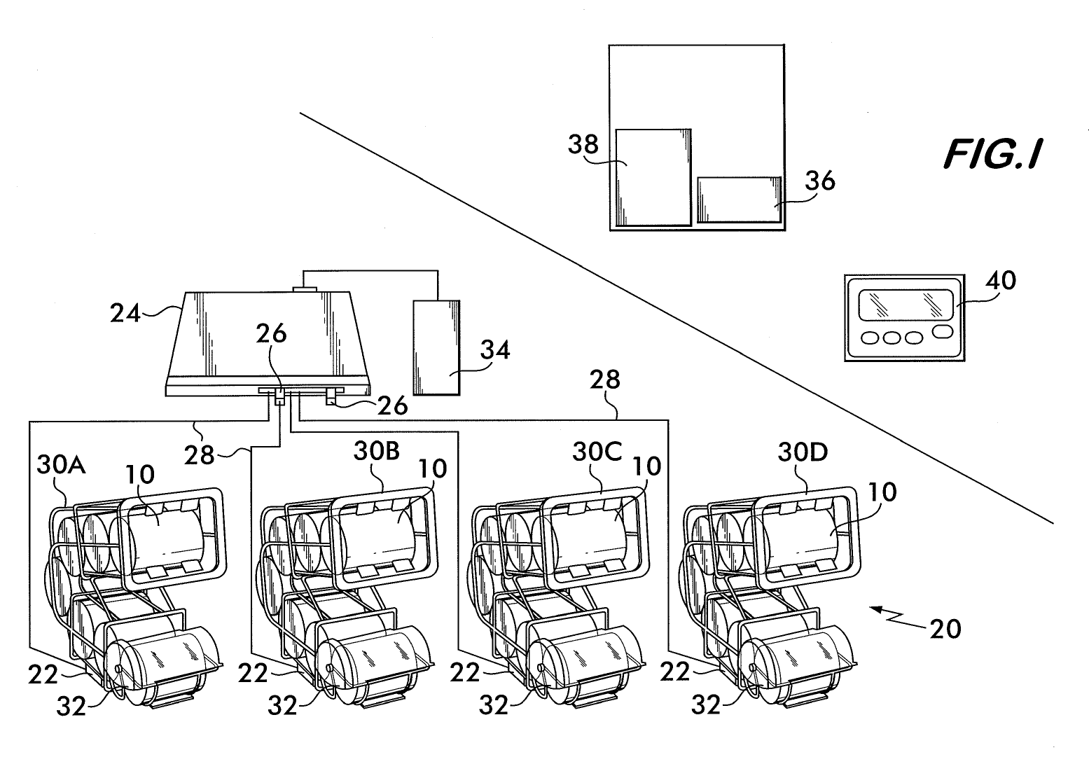

Referring now to the various figures of the drawings wherein like reference characters refer to like parts, there is shown at 20 in FIG. 1, an exemplary fixture monitoring system (“FMS”) constructed in accordance with the subject invention. The FMS system provides a cost-effective method for monitoring the “status” of various types of product or item dispensing fixtures and products sold in retail environments. The primary purpose of the FMS is to provide automatic detection and notification of undesirable conditions, specifically: out-of-stock, low-stock, and rapid product dispensing or removal. This notification provides the opportunity to take immediate action against such conditions, which can affect store profitability and loss. There are also alternative and secondary applications for this system.

The product Fixture Monitoring System (FMS) is arranged to provide a high degree of flexibility, allowing it to monitor virtually any type of product or fixture that can be properly configured with a sensing device or switch. The sensing device or switch will be referred to hereinafter generically as a “sensor.” The most basic FMS system 20 consists of two major components, namely, at least one sensor (FIGS. 1, 5 and 6) 22 that monitor product presence and movement, and an electronic device or unit 24, referred to hereinafter as the FMS Intelligent Controller or “FMS-IC”, which is a microprocessor based input/output device that serves as the “brain” of the FMS system 20.

As will be described in more detail later, the FMS-IC unit 24 mounts in or near a fixture/dispenser in or on which the products to be monitored are disposed. The single sensor 22 or the plural sensors 22, as the case may be, is(are) connected to respective inputs 26 of the FMS-IC unit 24 with respective short lengths of conductor cable 28. The details of the sensor(s) will be described later. Suffice it for now to state that the sensors can be of any suitable type. In the examples described herein the sensors comprise conventional switches, such as a single pole microswitch. Other types of switches or other types of sensors can be used. In any case, each sensor 22 is arranged to provide an electrical signal when actuated, e.g., when its contacts close, via a respective cable 28 to a respective input 26 of the FMS-IC unit 24 to trigger that unit.

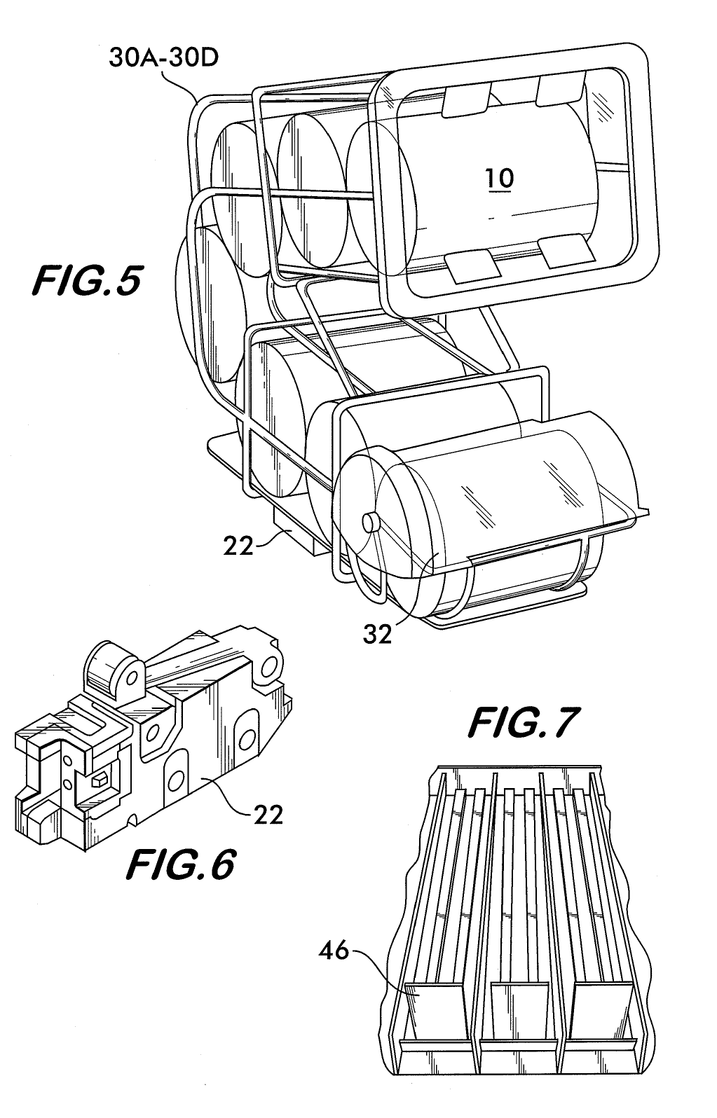

In FIG. 1, the FMS system 20 is shown in an application monitoring dispensing of cans 10 of infant formula. In this application, the cans of infant formula are held and displayed in four gravity-feed display fixtures 30A, 30B, 30C and 30D. The construction of each of these fixtures is best seen in FIG. 5. It should be pointed out at this juncture that the system 20 need not have four fixtures, but can include only one fixture or can have any number of fixtures up to eight when using the exemplary FMS-IC unit 24 (since that exemplary unit 24 has eight inputs 26). Other FMS-IC units 24 can be provided having more than eight inputs.

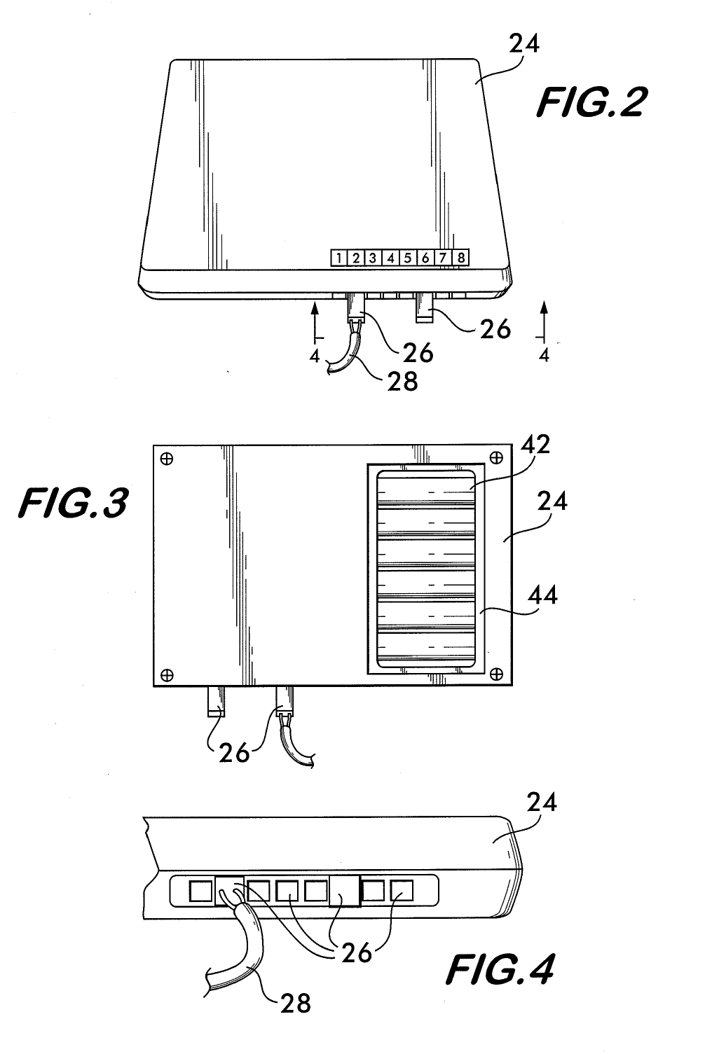

In the exemplary embodiment shown, the fixtures 30A-30D are arranged to be secured to a shelf (not shown) in a commercial environment, e.g., a store. Each fixture 30A-30D includes a path in which the plural individual cans 10 of the infant formula are located and pass. The path extends downward so that the cans can roll down the path to an outlet 32 of the fixture under the force of gravity. A sensor 22, like shown in FIG. 6, is mounted on the fixture adjacent the outlet 32 as depicted in FIG. 5. As mentioned earlier each sensor 22 is electrically connected via a respective conductor or cable 28 to a respective electrical connector input 26 of the FMS-IC unit 24 as shown in FIGS. 2-4. Each sensor 22 is arranged to be closed when a can of formula rolls over it. Thus, as each can 10 of formula is dispensed or removed from an associated fixture an electrical signal indicative thereof is provided to the FMS-IC unit 24. When at least one of the connected fixtures lack a can in their respective paths, the FMS-IC unit 24 of the system 20 provides an electrical output signal which constitutes a low-stock alert. In other words, the system 20 is programmable to provide the low-stock alert when any preselected number of fixtures 30A-30D lack a preselected number of cans in their respective paths. For example, in the exemplary embodiment shown in FIG. 1, the system 20 provides the low-stock alert when one, two, three or all of the fixtures lack at most two cans, since the sensors 22 are positioned to monitor the second can 10 from the outlet 32.

The FMS-IC unit 24 is arranged so that when a sensor triggers an input 26 of the FMS-IC unit, an adjustable timing window or period established by the unit opens (commences). During the timing window or period, the unit 24 counts the inputs received from the sensor(s) 22. If the total count, accumulated across all inputs 26, reaches a preset threshold, the FMS-IC unit 24 provides an electrical output signal for a predetermined period of time, e.g., two (2) seconds. This output signal is provided by a single “form-c” style switch and serves as a “dispense rate alert” that serves to warn store personnel when too many products are removed within a time period, thereby indicating a possible on-going large scale theft.

The criteria for establishing when a dispense rate alert signal is to be provided is established in the unit 24. To that end there are two settings that may be adjusted on the unit, each with a separate dial. These settings may be changed without opening or reprogramming the case or housing of the unit 24. The two adjustable settings are “Time” and “Count”. The “Time” setting establishes the window or period during which item dispensing counts are to be monitored and is set to a default value of 5-90 seconds. However, the unit 24 can support custom configurations for any time range. The dial has indicia thereon indicative of the particular time window to be established, e.g., a setting of “0” is 5 seconds, “1” is 10 seconds, “2” is 20 seconds, etc. The “Count” setting dial establishes the maximum number of counts for a given time period. The default settings for the “Count” are 1-9 counts, but the unit 24 supports custom configurations for any number required. Thus, the setting of the Time dial for the Time and the setting of the Count dial for the Count establishes the number of sensor inputs required (in the time range specified above) to cause a “dispense rate alert” output.

In addition to counting the number of inputs triggered, the FMS-IC unit 24 also monitors its inputs 26 to ensure that all are “normal”—meaning that they sense merchandise in place. When all inputs are determined to be “off normal” for a short period of time, the unit 24 activates another dedicated output providing an electrical signal. This signal is a “low” or “no” stock signal (depending on the sensor/application) and can be used to provide notification to store personnel of the need to restock the display fixture. This output is also provided by a single “form-c” style switch, which latches until the product(s) is(are) replaced.

The output signals from the FMS-IC 24 device, whether in the form of “dispense rate alert” signals, “low” or “no stock” signals or any combination thereof, can be used to trigger an external system to warn store personnel or others of the abnormal occurrence. The external systems can take any desired configuration. One exemplary external system is shown in FIG. 1. To that end, the FMS-IC unit 24 provides its output signals to a wireless transmitter 34. The transmitter 34 is arranged to wirelessly transmit the alarm or the low or out of stock signals to some remotely located receiver. The external system may also include one or more of a video display, an alarm sounder, light, or any other equipment the retailer may desire. In the embodiment shown, the external system includes a wireless receiver 36, a paging transmitter 38 and an alpha pager 40, all located on one or more remote locations, e.g., a back room of the retail establishment. Any of the outputs described above could also be used to trigger in-store marketing displays, CCTV recording systems, audio recordings, coupon dispensers, etc.

As should be appreciated by those skilled in the art the FMS system 20 can be mounted directly to the shelves of various manufacturers and serves to detect unusual product conditions at the fixture location, transmit that information back to a central location with the store, and notify the store employee.

The FMS-IC unit 24 can be of any suitable construction. In the exemplary embodiment shown in FIGS. 2-4, it is powered by batteries 42 (e.g., six common “AA” alkaline batteries), which provide up to one year of operation. The battery compartment 44 is on the bottom of the unit as shown in FIG. 3, and is covered with an openable battery door (not shown). As mentioned earlier the FMS-IC 24 includes eight inputs 26. Each is in the form of a plug-in terminal. The terminals enable the unit to connect to multiple fixtures and/or sensors, while automatically determining how many terminals are in use.

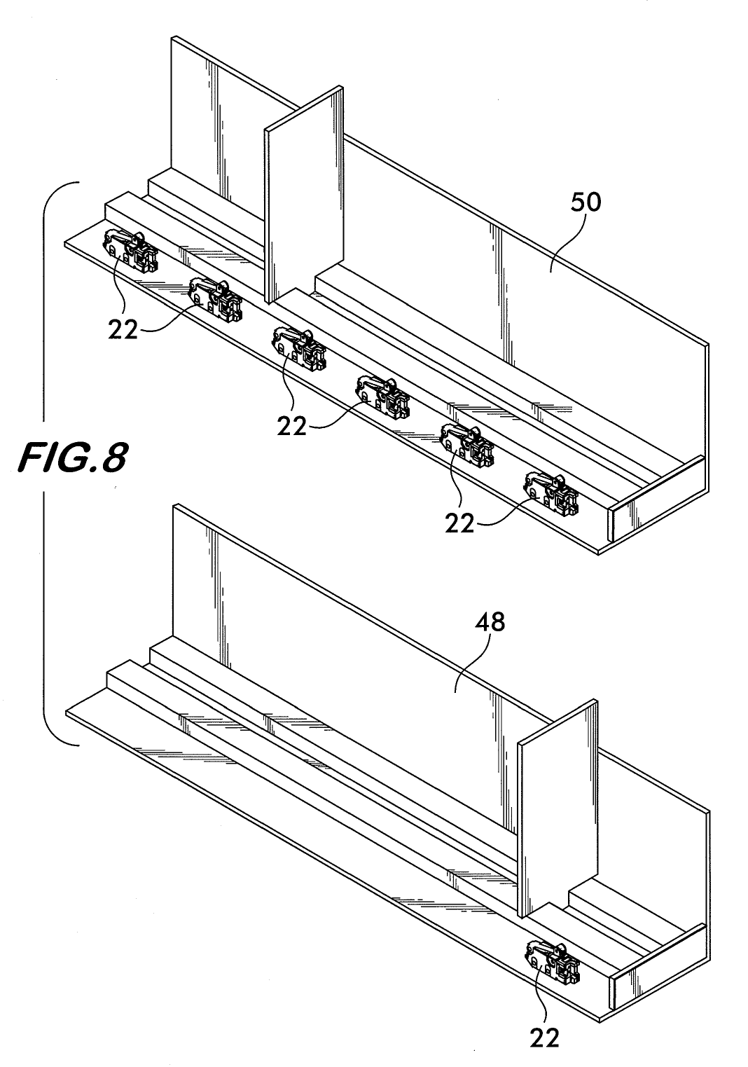

It must be pointed out at this juncture, that the system 20 of this invention is not limited to use with gravity feed dispensers like that described above with reference to FIGS. 1 and 5. Thus, the system 20 can be used with an item display or dispenser making use of what is referred to as a product “pusher”. A product pusher is a conventional device, with exemplary embodiments thereof being shown in FIGS. 7-9B. In dispensing application making use of product pushers, the pusher is outfitted with one or multiple sensors 22 to provide triggering of the FMS-IC unit 24 as products are removed. Due to the variety of products that may be displayed with pushers, this dispensing application will involve several combinations of pusher assemblies, switches, and/or product guards.

In FIG. 7 there is shown one typical conventional pusher fixture having a pusher 46 making use of multiple independent spring-loaded paddles to bring the merchandise items to the front of the display.

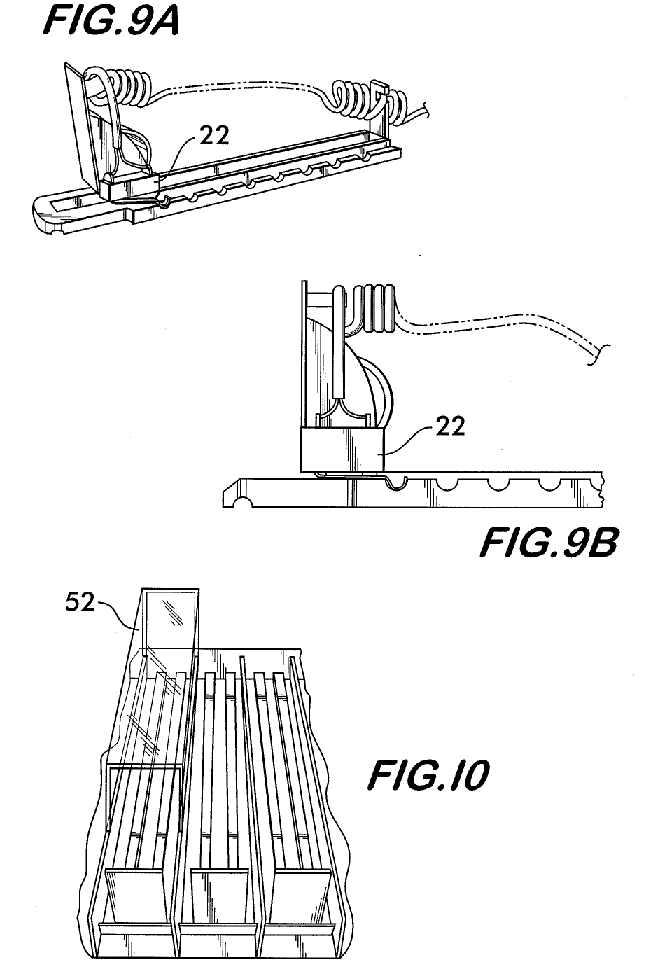

In FIG. 8 there is shown an example of single-switch pusher 48 and multi-switch pusher 50. The single switch version is appropriate for use when the merchandise has a guard 52 (FIG. 10) over the top that allows only one item of merchandise to be removed at a time. As items are removed, a switch 22 (not shown) beneath the front-most item is triggered. The items behind are then pushed forward onto the switch and the system 20 is ready to count again. The multi-switch version 48 is appropriate for open displays where multiple products could be removed at one time. In such a case the pusher triggers sensors 22 along its path as it moves forward, so removing multiple products results in multiple inputs being communicated to the FMS-IC unit 24. Switch quantities and spacing can be varied to accommodate different product sizes.

In FIGS. 9A and 9B there is shown an example of a pusher mechanism for use in the subject invention. In such an arrangement the sensor or switch 22 is located so that it rides on the spring-loaded paddle and contacts multiple slots installed along the track.

In FIG. 10 there is shown a pusher fixture making use of a guard 52 to prevent multiple products from being removed one at a time. In FIG. 11 there is shown an alternative fixture that includes a guard arrangement to prevent multiple products from being removed at one time. Such a device can form a portion of the system 20 of this invention and include a sensor 22 (not shown), for example, adjacent support rails under the products.

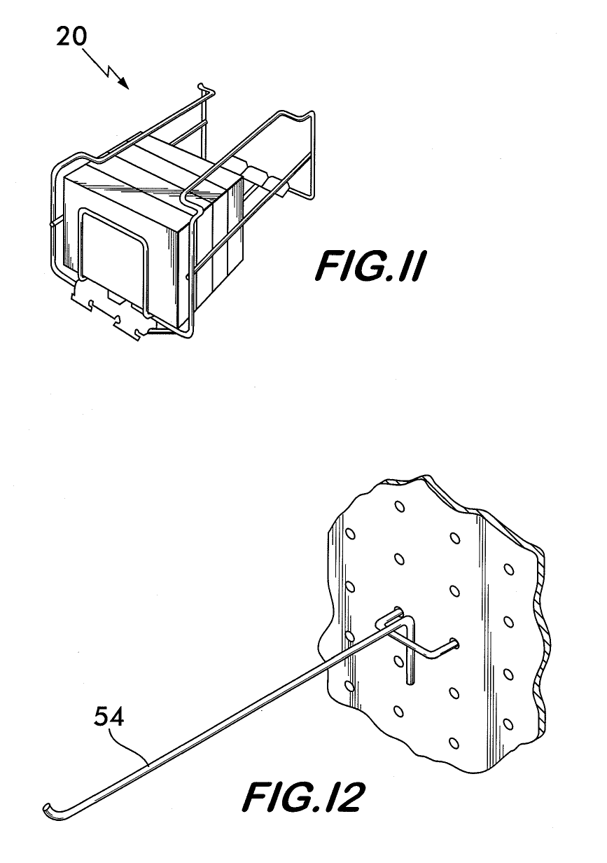

Other dispensing/display applications which can make use of the subject invention are contemplated. For example, one such application is a peg hook application, such as shown in FIG. 12. In such an application a simple conventional peg hook 54 would be made to incorporate a sensor 22 (not shown) to detect item removal therefrom. Another contemplated application is an “open shelf” application (not shown). While peg-hook and open shelf applications are likely to be more difficult to implement than pusher applications (such as shown in FIGS. 7-10), or enclosed fixture applications (like the infant formula display of FIGS. 1 and 5, or the fixture of FIG. 11), they are nevertheless contemplated by this invention and form a part of it.

As will be appreciated by those skilled in the art from the foregoing, the exemplary FMS system 20 shown and described above has the following notable features. The FMS-IC unit 24 is battery powered, e.g., uses six conventional “AA” alkaline batteries, providing up to one year of operation and is housed within a small enclosure for easy installation behind, under, or within the merchandise display fixture. The unit 24 can support up to eight (8) sensor inputs for connecting multiple fixtures or product sensing devices and automatically determines how many of the inputs are in use. The unit also includes an auxiliary input for special applications and two outputs for connection to external systems (described above). As mentioned above the outputs are provided by single “form-c” style switches. The time window or period and event counts per period are individually adjustable via respective adjustable code wheels or dials. The system also includes output LEDs that display activation of each sensor, output status, and a low-battery condition. These outputs may be used for installation/troubleshooting, or as a visual indication that the system is installed, providing a theft deterrent. All input and outputs are provided by removable terminal plugs. The battery compartment in the housing includes an easy-to-open access door thereto. Lastly, the unit 24 includes an RS232 serial communication port for connection to a computer or some other processing device.

While the invention has been described in detail and with reference to specific examples thereof, it will be apparent to one skilled in the art that various changes and modifications can be made therein without departing from the spirit and scope thereof.

1-20. (canceled)

21. A method of monitoring a product display device or fixture, the product display device or fixture being arranged to enable items of merchandise to be removed from it by patrons of a commercial environment, the product display device or fixture comprising at least one storage area for storing the plural items of merchandise and at least one outlet coupled to said storage area from which individual items of merchandise can be removed by the patrons or dispensed to the patrons, said method comprising:
(A) directly detecting the presence of an item of merchandise at a predetermined position adjacent the at least one storage area with at least one sensor;
(B) sensing the removal or dispensing of one of said items of merchandise from said predetermined position of said product display device or fixture with said at least one sensor;
(C) providing a first electrical signal indicative thereof based on the removal or dispensation of said item of merchandise from said predetermined position in automatic response to the removal or dispensation; and
(D) processing said first electrical signal to enable the rate that said items of merchandise are removed or dispensed from said product display device or fixture to be determined by at least one electronic device, thereby providing an indication of possible item theft.

22. The method of claim 21, whereupon said processing step comprises establishing a timing window or period, during which the number of said first electrical signals are counted, to determine if the total number of first electrical signals received during said timing window reaches a preset threshold, and if so providing a dispense rate alert signal output.

23. The method of claim 22, wherein said timing window or period is adjustable.

24. The method of claim 22, wherein said number of first electrical signals to be counted in said timing window or period is adjustable.

25. The method of claim 22, wherein said timing window or period is adjustable and wherein said number of first electrical signals to be counted in said timing window or period is adjustable.

26. The method of claim 21, further comprising:
(E) monitoring the presence of a sufficient inventory of items of merchandise in the product display or fixture to provide a low stock or no stock output signal indicative of low stock or no stock of the items of merchandise, respectively.

27. The method of claim 21, further comprising coupling the at least one sensor to the electronic device with an electrical conductor.

28. The method of claim 22, further comprising providing the dispense rate alert signal output to an external system or device.

29. A product display device or fixture monitoring system, the product display device or fixture being arranged to enable items of merchandise to be removed from it by patrons of a commercial environment, the product display device or fixture comprising at least one storage area for storing the plural items of merchandise and at least one outlet coupled to said storage area from which individual items of merchandise can be removed by the patrons or dispensed to the patrons, said monitoring system comprising:
means for directly detecting the presence of an item of merchandise at a predetermined position adjacent the at least one storage area with at least one sensor;
means for sensing the removal or dispensing of one of said items of merchandise from said predetermined position of said product display device or fixture with said at least one sensor;
means for providing a first electrical signal indicative thereof based on the removal or dispensation of said item of merchandise from said predetermined position in automatic response to the removal or dispensation; and
means for processing said first electrical signal to enable the rate that said items of merchandise are removed or dispensed from said product display device or fixture to be determined by at least one electronic device, thereby providing an indication of possible item theft.

30. The monitoring system of claim 29, whereupon said means for processing includes means for establishing a timing window or period, during which the number of said first electrical signals are counted, means for determining if the total number of first electrical signals received during said timing window reaches a preset threshold, and if the total number of first electrical signals received during said timing window reaches the preset threshold, then means for providing a dispense rate alert signal output.

31. The monitoring system of claim 30, wherein said timing window or period is adjustable.

32. The monitoring system of claim 30, wherein said number of first electrical signals to be counted in said timing window or period is adjustable.

33. The monitoring system of claim 30, wherein said timing window or period is adjustable and wherein said number of first electrical signals to be counted in said timing window or period is adjustable.

34. The monitoring system of claim 30, further comprising means for providing the dispense rate alert signal output to an external system or device.

35. The monitoring system of claim 29, further comprising means for monitoring the presence of a sufficient inventory of items of merchandise in the product display or fixture to provide a low stock or no stock output signal indicative of low stock or no stock of the items of merchandise, respectively.

36. The monitoring system of claim 29, further comprising means for coupling the at least one sensor to the electronic device with an electrical conductor.

37. The monitoring system of claim 29, wherein said product display device or fixture is in the form of a fixture defining a path through it, said path making up said storage area and being configured to enable said items of merchandise to move therethrough, whereupon at least one of said item of merchandise appears at said at least one outlet of said dispensing device to be removed therefrom by the patron.

38. The monitoring system of claim 29, wherein said electronic device is a microprocessor-based device and wherein said at least one sensor is arranged to provide a trigger signal to said microprocessor-based device upon the detection of said item of merchandise thereat, whereupon said microprocessor-based device initiates a timing window or period, during which said microprocessor-based device counts the number of said first electrical signals and determines if the total number of first electrical signals received during said timing window reaches a preset threshold, and if so provides a dispense rate alert signal output.
